(19) United States
(12) Patent Application Publication
(10) Pub. No.: US 2020/0116302 A1
(43) Pub. Date: Apr. 16, 2020

(54) Lubricant Delivery System Comprising One or More Sensing Devices and Related Methods

(71) Applicant: Supreme Electrical Services, Inc. DBA Lime Instruments, Houston, TX (US)

(72) Inventors: Cory Glass, Houston, TX (US); Toby King, San Antonio, TX (US); Robert Raphael Dolan, Houston, TX (US); Connor William Spitzer, Houston, TX (US)

(73) Assignee: Supreme Electrical Services, Inc. DBA Lime Instruments, Houston, TX (US)

(21) Appl. No.: 16/160,818

(22) Filed: Oct. 15, 2018

(51) Int. Cl. F16N 29/02; F16N 7/38; F16N 19/00; F16N 11/00

(52) U.S. Cl. CPC F16N 29/02; F16N 7/38; F16N 19/00; F16N 2270/20; F16N 2230/02; F16N 2250/08; F16N 2250/16; F16N 11/00

(57) ABSTRACT

Lubricant delivery systems, related methods, and computer program products for facilitating the assessment of operating conditions of one or more lubricant recipients are disclosed. In an aspect, assessment(s) facilitated by the lubricant delivery systems and related methods and computer program products of the present disclosure may be used to maintain a lubricant delivery process that delivers a lubricant supply to one or more recipients in order to minimize or prevent damage. Assessment(s) may be at least partially facilitated by one or more sensing devices that may be configured to detect, measure, or sense one or more operating conditions of at least one recipient in order to identify situations wherein the recipient(s) may be operating without adequate supply, amount, density, viscosity, and/or composition of one or more lubricants. A user and/or computing device may make one or more adjustments to at least one lubricant delivery process to the recipient(s).

### FIELD OF THE DISCLOSURE

The present disclosure generally relates to lubricant delivery systems and related methods and computer program products and more particularly to lubricant delivery systems and related methods and computer program products that comprise at least one sensing device configured to detect at least one operating condition of at least one lubricant recipient.

### BACKGROUND

The statements in this section merely provide background information related to the present disclosure and may not constitute prior art.

Friction based forces have been problematic in the design of moving pieces of equipment or machinery for many years. Any apparatus that includes moving parts, particularly where there is metal-on-metal contact or metal-on-elastomer contact, is subject to experiencing an unwanted amount of friction that generates potentially damaging heat and wear.

One type of apparatus in which friction and heat are problematic includes pumping mechanisms. Pumping mechanisms comprise packing assemblies that may experience friction when one or more seals associated with a given pumping mechanism fail or become deformed, such as from debris from improper installation, from a lack of proper lubrication, and the like. This failure or deformation can create costly maintenance and repair issues.

In an effort to minimize the negative effects associated with unwanted friction, many types of lubricants have been developed that allow moving parts to contact and engage each other while experiencing fewer resistive forces. Lubrication systems have been designed that deliver various types of lubricants to a variety of receiving components that may benefit from being lubricated. While such lubrication systems have been helpful at maintaining machines and systems that have one or more moving parts, they are not as effective as they could be, in that they do not account for situations in which contacting parts change speed and move faster or slower and thus generate more or less friction and heat than originally anticipated. In fact, they do not take temperature into account at all in their lubricant delivery processes, and thus cannot mitigate unwanted heat increases in a timely manner.

Given the foregoing, lubricant delivery systems, methods, and computer program products are needed that allow one or more issues with one or more lubricant recipients to be identified in a timely manner. Additionally, lubricant delivery systems, methods, and computer program products that allow a user to address and/or resolve one or more issues with one or more lubricant recipients in a timely manner are needed. Lubricant delivery systems, methods, and computer program products that mitigate or prevent damage to one or more lubricant recipients are also desired.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing lubricant delivery systems, methods, and computer program products that facilitate the identification of and, if necessary, resolution of one or more issues affecting one or more lubricant recipients in a timely manner. Specifically, in an aspect, lubricant delivery systems, methods, and computer program products are disclosed that may comprise at least one sensing device that may be configured to detect at least one operating condition of at least one lubricant recipient, in order to determine if the lubrication needs of the lubricant recipient(s) are being fully met. By way of example and not limitation, the at least one operating condition may comprise at least one of: a temperature, a stroke count, a revolution count, a lubricant usage amount, and an operating time, of at least one portion of the at least one lubricant recipient. The sensing device(s) may be configured upon and/or within any appropriate portion of the lubricant recipient(s) where they may be able to make adequate detections. For example, in some nonlimiting exemplary embodiments, one or more sensing devices may be configured within the packing bore and/or sealing area of one or more pressure pumps, etc.

In some aspects, the sensing device(s) used with the lubricant delivery systems, methods, and computer program products of the present disclosure may be communicatively coupled to one or more computing devices, either wirelessly or via wired connectivity. Such computing devices may be configured with various computational instructions, or code, in the form of software or one or more software applications that, when executed on at least one computer processor, causes the at least one computer processor to perform certain steps or processes, including interpreting and/or analyzing detected data received from one or more sensing devices associated with a given lubricant delivery system, and/or presenting received data and/or performed data analysis to at least one user. In some additional aspects, the software or software applications may facilitate the ability of one or more users to instruct the computing device(s), via one or more input devices, to make one or more adjustments to at least one lubricant delivery process associated with one or more lubricant recipients, such as adjusting an amount, flow rate, density, viscosity, and/or composition of one or more lubricants being delivered to the lubricant recipient(s). In still some additional aspects, the software and/or software applications may cause the one or more computer processors associated with the one or more computing devices to make any necessary or desired adjustments to at least one lubricant delivery process in an at least semi-autonomous fashion, with only partial or no user input. In such aspects, the software and/or software applications may be programmed to implement one or more adjustments to the at least one lubricant delivery process in response to the detection of one or more changes in the operating conditions associated with a given lubricant recipient (e.g., increase lubricant delivery amount and/or flow rate when the temperature of the lubricant recipient gets too high, etc.).

In some aspects, one or more computing devices that may be used with the lubricant delivery systems, methods, and computer program products of the present disclosure may be configured to record and store data related to the operating conditions of one or more lubricant recipients, and/or to record and store data related to one or more changes to a lubricant delivery process associated therewith. Such data may be viewed by a user in substantially real time or at a later time, in order to troubleshoot, diagnose, or otherwise check the status of one or more problems or issues that may be experienced by one or more lubricant recipients.

In some aspects, at least one lubricant recipient used with the lubricant delivery systems, methods, and computer program products of the present disclosure may comprise a pressure pump that includes at least one sensing device, thereby taking the form of a “smart pump.” The smart pump may be configured to be communicatively coupled to one or more computing devices, either wirelessly or via wired connectivity, in order to receive instructions therefrom and/or submit data or operating information thereto. For example, the smart pump may receive instructions to vary its operating parameters, such as from the one or more computing devices and/or via at least one user input, or the smart pump may submit performance and/or operating data to the one or more computing devices (e.g., an internal temperature or speed of operation) for review, comparison, troubleshooting, and/or diagnostic purposes.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the maintenance of an adequate lubricant delivery process to at least one lubricant recipient, according to an aspect of the present disclosure.

FIG. 2 is an image depicting an exemplary lubricant delivery system with a section view of an exemplary smart pump, according to an aspect of the present disclosure.

FIG. 3 is an image depicting a second exemplary lubricant delivery system including at least one pumping mechanism, according to an aspect of the present disclosure.

FIG. 4 is an image depicting a pumping mechanism configured for use with the second exemplary lubricant delivery system, according to an aspect of the present disclosure.

FIG. 5 is a flowchart illustrating an exemplary process for facilitating the ability of at least one user to manually view at least one operating condition of at least one lubricant recipient and make at least one adjustment to at least one aspect of at least one lubricant delivery process to the at least one lubricant recipient, according to an aspect of the present disclosure.

FIG. 6 is a flowchart illustrating an exemplary process for facilitating the ability of at least one user to use at least one computing device to view at least one operating condition of at least one lubricant recipient and make at least one adjustment to at least one aspect of at least one lubricant delivery process to the at least one lubricant recipient, according to an aspect of the present disclosure.

FIG. 7 is a flowchart illustrating an exemplary process for facilitating the ability of at least one user to assess at least one operating condition of at least one lubricant recipient and make at least one adjustment to at least one aspect of at least one lubricant delivery process to the at least one lubricant recipient, according to an aspect of the present disclosure.

FIG. 8 is a flowchart illustrating an exemplary process for facilitating the ability of at least one computing device to detect at least one operating condition of at least one lubricant recipient, and make at least one adjustment to at least one aspect of at least one lubricant delivery process to the at least one lubricant recipient, according to an aspect of the present disclosure.

FIG. 9 is a block diagram of an exemplary computing system useful for implementing the present disclosure.

### DETAILED DESCRIPTION

The present disclosure is directed to lubricant delivery systems, methods, and computer program products for facilitating the assessment of one or more operating conditions of one or more lubricant recipients and using the assessment to maintain a lubricant delivery process that delivers an adequate lubricant supply to each lubricant recipient. Specifically, in an aspect, lubricant delivery systems and related methods and computer program products are disclosed that may comprise one or more sensing devices, each of which may be configured to detect at least one operating condition of at least one portion of at least one lubricant recipient. The sensing device(s) may be further configured to present operating condition data information to one or more users, in order to determine whether any adjustments need to be made to at least one lubricant delivery process associated with a given lubricant recipient. In some aspects, a user may utilize one or more computing devices to assess one or more operating conditions of at least one lubricant recipient and/or make changes to the lubricant delivery process associated with the lubricant recipient(s). In some additional aspects, one or more computing devices may be configured to assess and/or analyze received data pertaining to one or more operating conditions of at least one lubricant recipient, determine whether any changes need to be made to at least one lubricant delivery process associated with the lubricant recipient(s), and initiate such changes in an at least semi-autonomous manner with partial or no user input.

In some aspects, one or more computing devices that may be used with the lubricant delivery systems, methods, and computer program products of the present disclosure may be configured to record and store data related to the operating conditions of one or more lubricant recipients and/or to record and store data related to one or more changes to a lubricant delivery process associated therewith. Such data may be viewed by a user in substantially real time or at a later time in order to troubleshoot, diagnose, and/or otherwise check the status of one or more lubricant recipients and/or one or more lubricant delivery processes that may be associated therewith.

In some aspects, at least one lubricant recipient used with the lubricant delivery systems, methods, and computer program products of the present disclosure may comprise a pressure pump that includes at least one sensing device, thereby taking the form of a “smart pump.” Such smart pump may be configured to be communicatively coupled to one or more computing devices, either wirelessly or via wired connectivity, in order to receive instructions therefrom and/or submit data and/or operating information thereto. For example, the smart pump may receive instructions to vary its operating parameters, such as from the one or more computing devices and/or via at least one user input, or the smart pump may submit performance and/or operating data to the one or more computing devices (e.g., an internal temperature, speed of operation, etc.) for review, comparison, troubleshooting, or diagnostic purposes.

The term “lubricant delivery system” and/or the plural form of this term are used throughout herein to refer to any system, machine, apparatus, or device that may function, at least partially, either by itself or in conjunction with one or more additional systems, machines, apparatuses, or devices, to transfer at least one lubricant from at least one lubricant source to at least one lubricant recipient, such as storage tanks, reservoirs, fluid lines, tubes, pipes, hoses, pumping mechanisms, manifolds, valves, and the like.

The term “lubricant” and/or the plural form of this term are used throughout herein to refer to any substance, element, chemical, or compound that may be used to reduce the amount of friction between two or more physically contacting components, such as oil, grease, viscous lubricating fluid, putty, paste, and the like.

The term “lubricant source” and/or the plural form of this term are used throughout herein to refer to any location or structure configured to at least partially contain a removable amount of one or more lubricants, such as storage tanks, reservoirs, containers, blending apparatuses, and the like.

The term “lubricant recipient” and/or the plural form of this term are used throughout herein to refer to any machine, device, apparatus, system, or any portion or component thereof, that, while functioning, experiences at least one amount of unwanted friction and thereby requires at least one amount of at least one lubricant in order to function and/or be maintained properly, wherein such lubricant recipients may include pressure pumps (including any sealing areas, valves, and/or packing assemblies that may be associated therewith), other pumps, pieces of farming equipment, mining apparatuses, petrochemical systems, rear-end automotive bearings, wheel bearings, trailer bearings, auger bearings, crankshafts, pinion shafts, cam bearings, and the like.

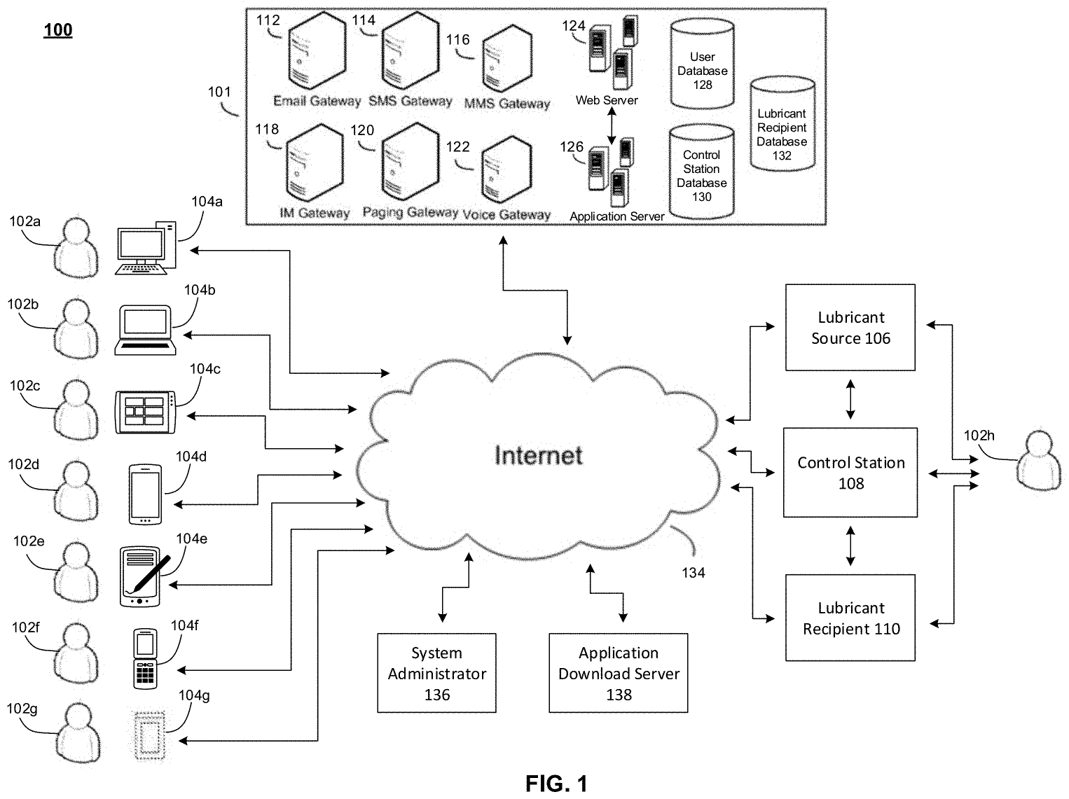

Referring now to FIG. 1, a block diagram of an exemplary system 100 for facilitating the maintenance of an adequate lubricant delivery process to at least one lubricant recipient 110, according to an aspect of the present disclosure, is shown.

Cloud-based, Internet-enabled device communication system 100 may include a plurality of users 102 (shown as users 102a-g in FIG. 1) accessing, via a computing device 104 (shown as respective computing devices 104a-g in FIG. 1) and a network 134, such as the global, public Internet—an application service provider's cloud-based, Internet-enabled infrastructure 101. In some aspects, a user application may be downloaded onto computing device 104 from an application download server 138. Application download server 138 may be a public application store service or a private download service or link. Computing device 104 may access application download server 138 via network 134. In another nonlimiting embodiment, infrastructure 101 may be accessed via a website or web application. Multiple users 102 may, simultaneously or at different times, access (via, for example, a user application) infrastructure 101 in order to engage in communication with other users 102, at least one lubricant source 106, at least one control station 108, and/or at least one lubricant recipient 110 or to access user database 128, control station database 130, and/or lubricant recipient database 132.

In some embodiments, a user 102 may communicate with one or more lubricant sources 106 via computing device 104, in order to initiate an adjustment to at least one aspect of a fluid delivery process emanating therefrom, and/or user 102 may communicate with one or more lubricant recipients 110 in order to assess one or more operating conditions thereof. In some additional aspects, a user 102h may communicate directly with lubricant source(s) 106, and/or lubricant recipient(s) 110 using at least one control station 108, and/or one or more input devices that may be associated therewith (such as, for example and not limitation, a mouse, keyboard, touchscreen, joystick, microphone, camera, scanner, chip reader, card reader, magnetic stripe reader, near field communication technology, and the like). By way of example and not limitation, control station 108 may comprise a computer kiosk communicatively coupled (either wirelessly (such as, for example and not limitation, via Bluetooth® (a wireless technology standard standardized as IEEE 802.15.1)) or via hardwired connectivity) to lubricant source 106 and/or lubricant recipient 110, or any similar computational and/or electronic device as may be apparent to those skilled in the relevant art(s) after reading the description herein. In still some additional aspects, control station 108 may be used to perform any of the tasks that may be performed using computing device 104.

In various aspects, computing device 104 may be configured as: a desktop computer 104a, a laptop computer 104b, a tablet or mobile computer 104c, a smartphone (alternatively referred to as a mobile device) 104d, a Personal Digital Assistant (PDA) 104e, a mobile phone 104f, a handheld scanner 104g, any commercially-available intelligent communications device, or the like.

As shown in FIG. 1, in an aspect of the present disclosure, an application service provider's cloud-based, communications infrastructure 101 may include an email gateway 112, an SMS (Short Message Service) gateway 114, an MMS (Multimedia Messaging Service) gateway 116, an Instant Message (IM) gateway 118, a paging gateway 120, a voice gateway 122, one or more web servers 124, one or more application servers 126, a user database 128, a control station database 130, and a lubricant recipient database 132. Application server(s) 126 may contain computational instructions, or code, that enables the functionality of system 100. User database 128, control station database 130, and/or lubricant recipient database 132 may not necessarily be contained within infrastructure 101, such as, but not limited to, user database 128, control station database 130, and/or lubricant recipient database 132 may be supplied by a third party. As will be apparent to those skilled in the relevant art(s) after reading the description herein, communications infrastructure 101 may include one or more additional storage communications, and/or processing components to facilitate communication within system 100, process data, store content, and the like.

User database 126 may be configured to store information pertaining to one or more users 102. In an aspect, a user 102 may comprise any individual or entity that may be responsible for and/or otherwise concerned with making sure that lubricant recipient(s) 110 receive an adequate supply of one or more lubricants in order to function properly and/or be properly maintained. User 102 may also be concerned with ensuring that lubricant source(s) 106 are functioning properly and/or contain an adequate amount of one or more lubricants to supply to lubricant recipient(s) 110. User 102 information that may be stored within user database 128 may include, by way of example and not limitation, a given user's 102 name, type (e.g., whether user 102 is an individual, entity, nonprofit organization, etc.), account or profile information (e.g., account settings, account usage history, background information regarding user 102, etc.), location, infrastructure 101 usage history, login credentials (including, but not limited to, passwords, usernames, passcodes, pin numbers, fingerprint scan data, retinal scan data, voice authentication data, facial recognition information, and the like), and the like.

Control station database 130 may be configured to store information pertaining to at least one control station 108. In some aspects, by way of example and not limitation, control station 108 may comprise a computer kiosk communicatively coupled (either wirelessly (such as, for example and not limitation, via Bluetooth® (a wireless technology standard standardized as IEEE 802.15.1)) or via hardwired connectivity) to lubricant source(s) 106 and/or lubricant recipient(s) 110 and configured to identify, detect, present, interpret, and/or analyze one or more operating conditions of lubricant recipient(s) 110 and/or initiate one or more changes in at least one lubricant delivery process thereto and/or control station 108 may be configured to identify, detect, present, interpret, and/or analyze one or more aspects of lubricant source(s) 106; or, control station 108 may comprise any similar computational and/or electronic device that may be apparent to those skilled in the relevant art(s) after reading the description herein. Control station 108 information that may be stored within control station database 130 may include, by way of example and not limitation, control station 108 usage history (e.g., which user(s) 102 have used control station 108, how long various control station 108 usage sessions have lasted, data and/or information that has been transferred and/or viewed via control station 108, and the like), control station 108 manufacturer information, control station 108 specifications and/or capabilities, list of adjustments to lubricant delivery process(es) to lubricant recipient(s) 110 that have been initiated via control station 108, list of lubricant recipient 110 issues or problems that have been sensed or detected using control station 108, control station 108 infrastructure 101 usage history, and the like.

Lubricant recipient database 132 may be configured to store information pertaining to one or more lubricant recipients 110. In an aspect, a lubricant recipient 110 may comprise any machine, device, apparatus, system, or any portion or component thereof, that, while functioning, experiences at least one amount of unwanted friction, and thereby requires at least one amount of at least one lubricant in order to function and/or be maintained properly. By way of example and not limitation, lubricant recipient(s) 110 may comprise one or more pressure pumps (including any sealing areas, valves, and/or packing assemblies that may be associated therewith), other pumps, pieces of farming equipment, mining apparatuses, petrochemical systems, rear-end automotive bearings, wheel bearings, trailer bearings, auger bearings, crankshafts, pinion shafts, cam bearings, and the like, as well as any other machine(s), device(s), apparatus(es), system(s), or portion(s) or component(s) thereof that comprise rotating or linear friction areas, such as where there is metal-on-metal contact and/or metal-on-elastomer contact. Lubricant recipient 110 information that may be stored within lubricant recipient database 132 may include, by way of example and not limitation, a given lubricant recipient's type (e.g., machine type, purpose of use, etc.), manufacturer brand and/or information, account or profile information (e.g., account settings, account usage history, lubricant recipient 110 background information and/or specifications, etc.), list of instances wherein operating conditions for lubricant recipient 110 were found to not be acceptable, list of times a lubricant delivery process associated with lubricant recipient 110 had to be adjusted and how it was adjusted (e.g., increased lubricant flow rate to account for temperature increase, adjusted lubricant composition, etc.), lubricant requirement information (actual and/or predetermined), infrastructure 101 usage history, login credentials required to access and/or utilize lubricant recipient(s) 110 (including passwords, usernames, passcodes, pin numbers, fingerprint scan data, retinal scan data, voice authentication data, facial recognition information, and the like), at least one predetermined standard or value (or a range thereof) for lubricant recipient(s) 110 (e.g., adequate or optimal operating conditions and/or lubricant requirements), and the like.

User database 128, control station database 130, and lubricant recipient database 132 may each be physically separate from one another, logically separate, or physically or logically indistinguishable from some or all other databases.

A system administrator 136 may access infrastructure 101 via the Internet 134 in order to oversee and manage infrastructure 101.

As will be appreciated by those skilled in the relevant art(s) after reading the description herein, an application service provider—an individual person, business, or other entity—may allow access, on a free registration, paid subscriber, and/or pay-per-use basis, to infrastructure 101 via one or more World-Wide Web (WWW) sites on the Internet 134. Thus, system 100 is scalable.

As will also be appreciated by those skilled in the relevant art(s), in an aspect, various screens may be generated by server 124 in response to input from user(s) 102 over Internet 134. As a nonlimiting example, server 124 may comprise a typical web server running a server application at a website which sends out webpages in response to Hypertext Transfer Protocol (HTTP) or Hypertext Transfer Protocol Secured (HTTPS) requests from remote browsers on various computing devices 104 being used by various uses 102. Thus, server 124 is able to provide a graphical user interface (GUI) to users 102 that utilize system 100 in the form of webpages. These webpages are sent to the user's 102 PC, laptop, mobile device, PDA, or like device 104, and would result in the GUI being displayed.

As will be appreciated by those skilled in the relevant art(s) after reading the description herein, alternate aspects of the present disclosure may include providing a tool for facilitating the assessment of one or more operating conditions of one or more lubricant recipients 110 and/or making one or more adjustments to one or more aspects of at least one lubricant delivery process for supplying at least one amount of at least one lubricant from at least lubricant source 106 to lubricant recipient(s) 110 via computing device(s) 104 and/or control station(s) 108 as a stand-alone system (e.g., installed on one server PC) or as an enterprise system wherein all the components of system 100 are connected and communicate via an inter-corporate Wide Area Network (WAN) or Local Area Network (LAN). For example, in an aspect where users 102 are all personnel/employees of the same company or are all members of the same group, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating the assessment of one or more operating conditions of one or more lubricant recipients 110 and/or the initiation of one or more adjustments to one or more aspects of at least one lubricant delivery process for supplying at least one amount of at least one lubricant from at least lubricant source 106 to lubricant recipient(s) 110 via a browser or operating system pre-installed with an application or a browser or operating system with a separately downloaded application on computing device(s) 104 and/or control station(s) 108. That is, as will be apparent to those skilled in the relevant art(s) after reading the description herein, the application that facilitates the assessment of one or more operating conditions of one or more lubricant recipients 110 and/or the initiation of one or more adjustments to one or more aspects of at least one lubricant delivery process for supplying at least one amount of at least one lubricant from at least lubricant source 106 to lubricant recipient(s) 110 may be part of the “standard” browser or operating system that ships with computing device 104 or control station 108 or may be later added to an existing browser or operating system as part of an “add-on,” “plug-in,” or “app store download.”

Communication infrastructure 101 may be encrypted to provide for secure communications. A security layer may be included that is configurable using a non-hard-cooled technique selectable by user 102 which may be based on at least one of: user 102, country encryption standards, etc. A type of encryption may include, but is not limited to, protection at least at one communication protocol layer such as the physical hardware layer, communication layer (e.g., radio), data layer, software layer, etc. Encryption may include human interaction and confirmation with built-in and selectable security options, such as, but not limited to, encoding, encrypting, hashing, layering, obscuring, password protecting, obfuscation of data transmission, frequency hopping, and various combinations thereof. As a nonlimiting example, the prevention of spoofing and/or eavesdropping may be accomplished by adding two-prong security communication and confirmation using two or more data communication methods (e.g., light and radio) and protocols (e.g., pattern and freq. hopping). Thus, at least one area of security, as provided above, may be applied to at least provide for communication being encrypted while in the cloud; communication with user 102, communication with lubricant source 106, communication with control station 108, and/or communication with lubricant recipient 110 that may occur via the Internet 134, a Wi-Fi connection, Bluetooth® (a wireless technology standard standardized as IEEE 802.15.1), satellite, or another communication link; communications between computing device(s) 104 and lubricant source(s) 106; communications between computing device(s) 104 and lubricant recipient(s) 110; communications between control station(s) 108 and lubricant source(s) 106; communications between control station(s) 108 and lubricant recipient(s) 110; communications between computing device(s) 104 and control station(s) 108; communications between Internet of Things devices and lubricant source(s) 106, control station(s) 108, and/or lubricant recipient(s) 110; and the like.

The Internet of Things, also known as IoT, is a network of physical objects or “things” embedded with electronics, software, sensors, and connectivity to enable objects to exchange data with the manufacturer, operator, and/or other connected devices based on the infrastructure of International Telecommunication Union's Global Standards Initiative. The Internet of Things allows objects to be sensed and controlled remotely across existing network infrastructure, creating opportunities for more direct integration between the physical world and computer-based systems, and resulting in improved efficiency, accuracy, and economic benefit. Each thing is uniquely identifiable through its embedded computing system but is able to interoperate within the existing Internet infrastructure. Communications may comprise use of transport layer security (“TLS”), fast simplex link (“FSL”), data distribution service (“DDS”), hardware boot security, device firewall, application security to harden from malicious attacks, self-healing/patching/firmware upgradability, and the like. Security may be further included by use of at least one of: obfuscation of data transmission, hashing, cryptography, public key infrastructure (PKI), secured boot access, and the like.

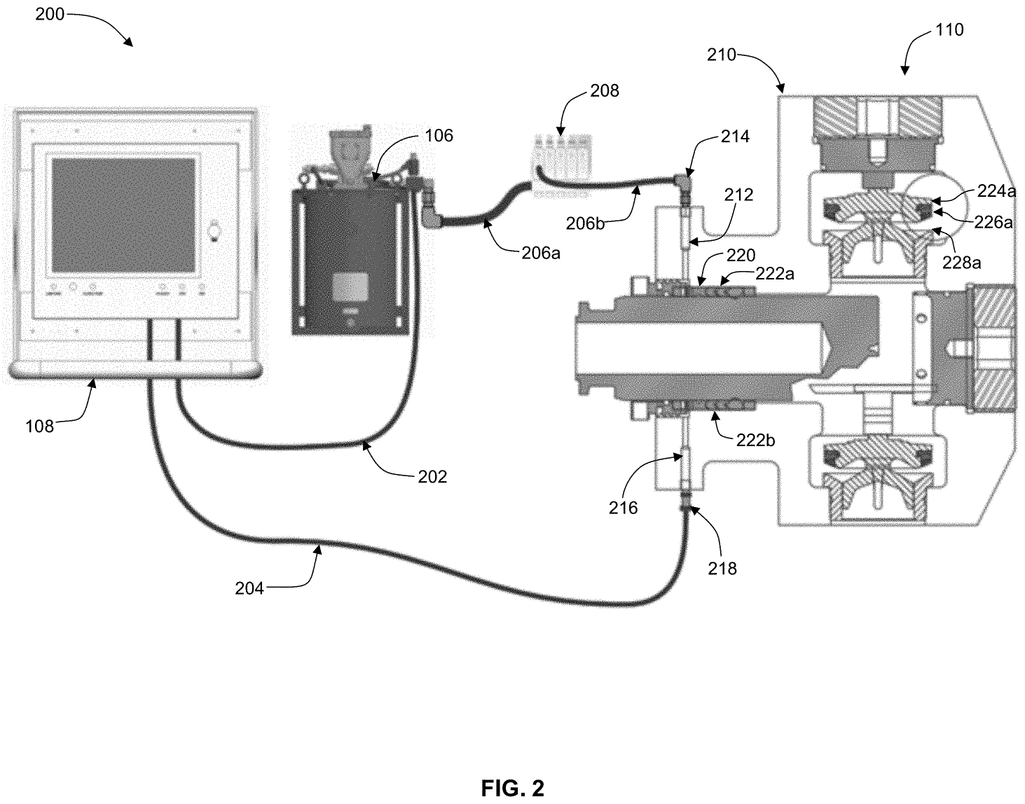

Referring now to FIG. 2, an image depicting an exemplary lubricant delivery system 200 with a section view of an exemplary smart pump 210, according to an aspect of the present disclosure, is shown.

Lubricant delivery system 200 may comprise at least one lubricant source 106 and at least lubricant recipient 110. As shown in FIG. 2, in some aspects, lubricant recipient 110 may take the form of at least one pumping mechanism (such as, by way of example and not limitation, a high pressure fracturing (or “frac”) pump or other reciprocating pump) that comprises at least one sensing device 216, thereby forming a “smart pump” 210. In some nonlimiting exemplary embodiments, sensing device 216 may comprise at least one resistance temperature detector (RTD) device, at least one thermowell, at least one thermocouple, at least one thermistor, at least one resistance thermometer, at least one pyrometer, at least one pressure transducer, at least one digital gauge, at least one densimeter, at least one Langmuir probe, and/or at least one infrared sensor, as well as any similar device(s) or mechanism(s) that may be apparent to those skilled in the relevant art(s) after reading the description herein, including any combination thereof. In some additional aspects, a given smart pump 210 may comprise at least three to five sensing devices 216; however, as will be apparent to those skilled in the relevant art(s) after reading the description herein, more or fewer sensing devices 216 may be used with a given smart pump 210.

In some aspects, lubricant delivery system 200 may further comprise at least one control station 108. By way of example and not limitation, control station 108 may comprise one or more computing devices 104 and/or one or more computer processers integrated with at least one display device (e.g., a display screen or monitor) and at least one input device (e.g., a mouse, keyboard, touchscreen, joystick, microphone, camera, scanner, chip reader, card reader, magnetic stripe reader, near field communication technology, and the like). In some nonlimiting exemplary embodiments, control station 108 may be communicatively coupled to one or more portions of lubricant delivery system 200 via wireless or wired connectivity. In some additional aspects, control station 108 may be configured at a location remote from lubricant delivery system 200 or control station 108 may be physically integrated with one or more portions of lubricant delivery system 200 (such as, by way of example and not limitation, by being mounted onto at least one portion of at least one lubricant source 106 via one or more fastening elements (e.g., nails, nuts, bolts, screws, washers, clips, clamps, clasps, hooks, pins, brackets, and the like, as well as any combination thereof)).

In some aspects, control station 108 (or computing device(s) 104) may include one or more computer processors that may be configured with various computational instructions, or code, in the form of software or one or more software applications that, when executed on the computer processor(s), causes the computer processor(s) to perform certain steps or processes, including interpreting and/or analyzing detected data and/or operating information received from one or more sensing devices 216 and/or presenting received data, operating information, and/or performed data analysis to at least one user 102 (not shown in FIG. 2) via at least one display device. In some additional aspects, the software or software applications may facilitate the ability of one or more users 102 to utilize at least one input device to make one or more adjustments to at least one lubricant delivery process associated with one or more lubricant recipients 110, such as adjusting an amount, flow rate, density, viscosity, and/or composition of one or more lubricants being delivered to lubricant recipient(s) 110. In still some additional aspects, the software and/or software applications may cause the one or more computer processors associated with control station 108 (or computing device(s) 104) to make any necessary or desired adjustments to at least one lubricant delivery process in an at least semi-autonomous fashion, with only partial or no input from user(s) 102. In such aspects, the software and/or software applications may be programmed to implement one or more adjustments to the at least one lubricant delivery process in response to one or more changes in the operating conditions associated with a given lubricant recipient 110 (e.g., for example and not limitation, control station 108 (or computing device(s) 104) may instigate an increase in a lubricant delivery amount and/or flow rate when an internal temperature within lubricant recipient 110 gets too high due to friction and then return lubricant delivery amounts and/or flow rates to normal quantities when the internal temperature reaches an acceptable level).

In aspects wherein control station(s) 108 (or computing device(s) may be integrated with lubricant delivery system 200 via wired connectivity, a given control station 108 (or computing device 104) may be communicatively connected to at least one lubricant source 106 (such as, for example and not limitation, a tank) via at least one lubricant source signal line 202. Via this (or any similar wireless or wired communication link) signal line 202, control station 108 (or computing device(s) 104) may be configured to provide instructions to lubricant source(s) 106 regarding one or more parameters of at least one lubricant delivery process to one or more lubricant recipients 110 (including, by ay of example and not limitation, a lubricant amount, a lubricant flow rate, a lubricant composition, a lubricant density, a lubricant viscosity, and the like). Lubricant source 106 may then be configured to deliver at least one amount of one or more lubricants to lubricant recipient(s) 110 according to the indicated parameters via one or more lubricant delivery lines 206 (shown as lubricant delivery lines 206a-b in FIG. 2) configured to at least partially contain at least one amount of at least one lubricant. In some aspects, lubricant delivery lines 206 may be integrated with at least one manifold apparatus 208. By way of example and not limitation, lubricant delivery line(s) 206 may comprise one or more sections of tubing, hosing, and/or piping composed of any appropriate materials, including but not limited to rubber, one or more metals, one or more plastics, polyvinyl chloride, other polymers, and the like. As will be appreciated by those skilled in the relevant art(s) after reading the description herein, other configurations and materials may be used for lubricant delivery line(s) 206 without departing from the scope of the present disclosure.

In aspects wherein at least one lubricant recipient 110 comprises a pumping mechanism 304 (such as smart pump 210), at least one amount of at least one lubricant may be delivered to one or more portions a soft packing assembly 222 (labeled as packing assemblies 222a-b in FIG. 2) that may be associated therewith via at least one injection device 212 (e.g., a nozzle, needle, or similar device or structure as may be apparent to those skilled in the relevant art(s) after reading the description herein) received by at least one female adapter 220. A particular lubricant delivery line 206 may be connected to a given injection device 212 via at least one injection connecting node 214. By way of example and not limitation, injection connecting node 214 may comprise a measured orifice; a spring-operated injector; a timed pump duration through a restricted or non-restricted hose, tube, or fitting; as well as any similar structure or mechanism as may be apparent to those skilled in the relevant art(s) after reading the description herein, including any combination thereof. In some additional aspects, at least one amount of at least one lubricant may be delivered to various other portions of a given pumping mechanism 304, including but not limited to one or more sealing areas thereof. Injection device 212 may be configured for use at a top or bottom lubrication port associated with a given pumping mechanism 304. Lubricant may be received at a power end of pumping mechanism 304, a fluid end of pumping mechanism 304, or both.

With further regard to aspects wherein control station(s) 108 (or computing device(s) 104) may be integrated with lubricant delivery system 200 via wired connectivity, a given control station 108 (or computing device(s) 104) may be communicatively coupled to at least one sensing device 216 via at least one sensing device signal line 204. By way of example and not limitation, sensing device signal line 204 may be configured to facilitate the ability of control station(s) 108 (or computing device(s) 104) to receive data from sensing device(s) 216, among other things. The received data may then be interpreted, analyzed, and/or otherwise processed by control station(s) 108 (or computing device(s) 104) and then presented to one or more users 102 via one or more display devices associated with control station(s) 108 (or computing device(s) 104). In some aspects, one end of each sensing device signal line 204 may be connected to one or more sensing devices 216 via at least one sensing device connection node 218.

In some aspects, wherein at least one lubricant recipient 110 comprises a pumping mechanism 304 (such as smart pump 210), the at least one sensing device 216 may be configured to sense at least one temperature or similar operating condition of one or more portions of soft packing assembly 222 and/or one or more sealing areas associated with packing assembly(ies) 222 and/or one or more other portions of pumping mechanism 304. Additionally or alternatively, in such aspects, one or more sensing devices 216 and/or injection device(s) 212 may be configured to sense one or more operating conditions of and/or deliver one or more amounts of lubricant to one or more valves 224 (labeled only as valve 224a in FIG. 2, for clarity), one or more valve inserts 226 (labeled only as valve insert 226a in FIG. 2, for clarity), and/or valve seats 228 (labeled only as valve seat 228a in FIG. 2, for clarity) that may be associated therewith.

Lubricant source signal line(s) 202 and/or sensing device signal line(s) 204 may comprise any appropriate form as may be apparent to those skilled in the relevant art(s) after reading the description herein, including, by way of example and not limitation, copper wiring, data cables, ethernet cables, optical fiber, and/or any other materials capable of transmitting one or more data signals, including any combination thereof.

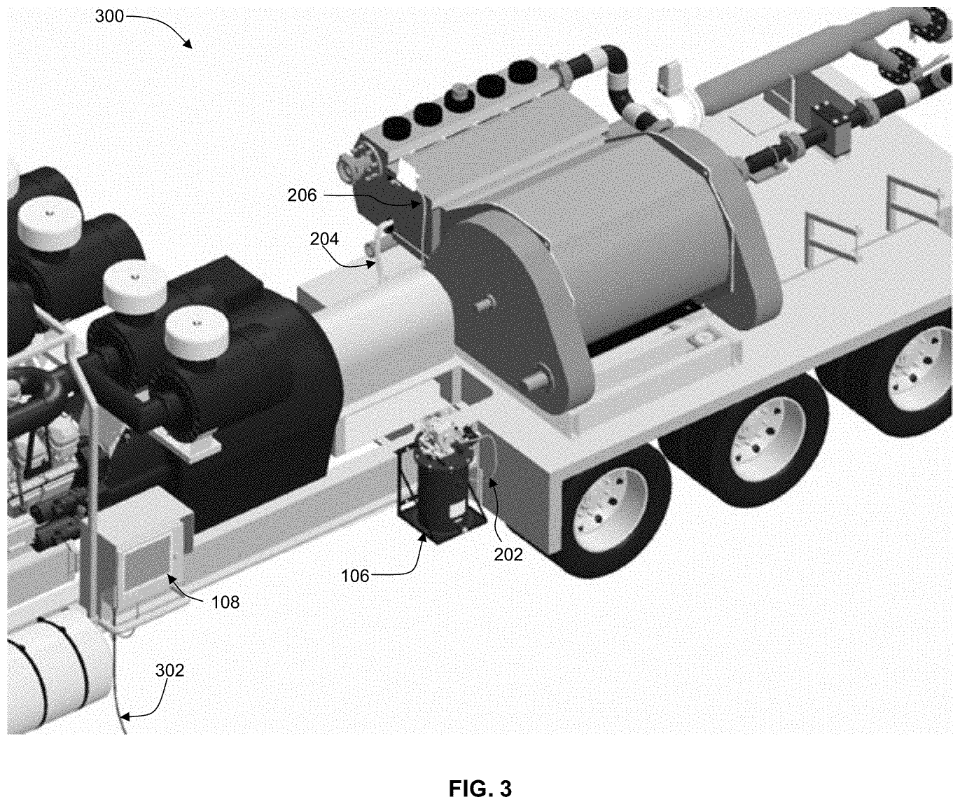

Referring now to FIG. 3, an image depicting a second exemplary lubricant delivery system 300 including at least one pumping mechanism 304, according to an aspect of the present disclosure, is shown.

In some aspects, lubricant source(s) 106, control station(s) 108 (and/or computing device(s) 104), and lubricant recipient(s) 110 (not labeled in FIG. 3) may be configured upon (e.g., physically mounted on) an apparatus, such as a truck, trailer, and/or skid that, by way of example and not limitation, may be used with one or more oilfield drilling operations. Such oilfield drilling operations may include the use of at least one remotely located data van, which may be configured to communicate with control station(s) 108 (and/or computing device(s) 104) either wirelessly or via wired connectivity, such as, for example and not limitation, via at least one data van signal line 302. As will be appreciated by those skilled in the relevant art(s) after reading the description herein, data van signal line(s) 302 may comprise a similar configuration and/or similar materials to lubricant source signal line(s) 202 and/or sensing device signal line(s) 204.

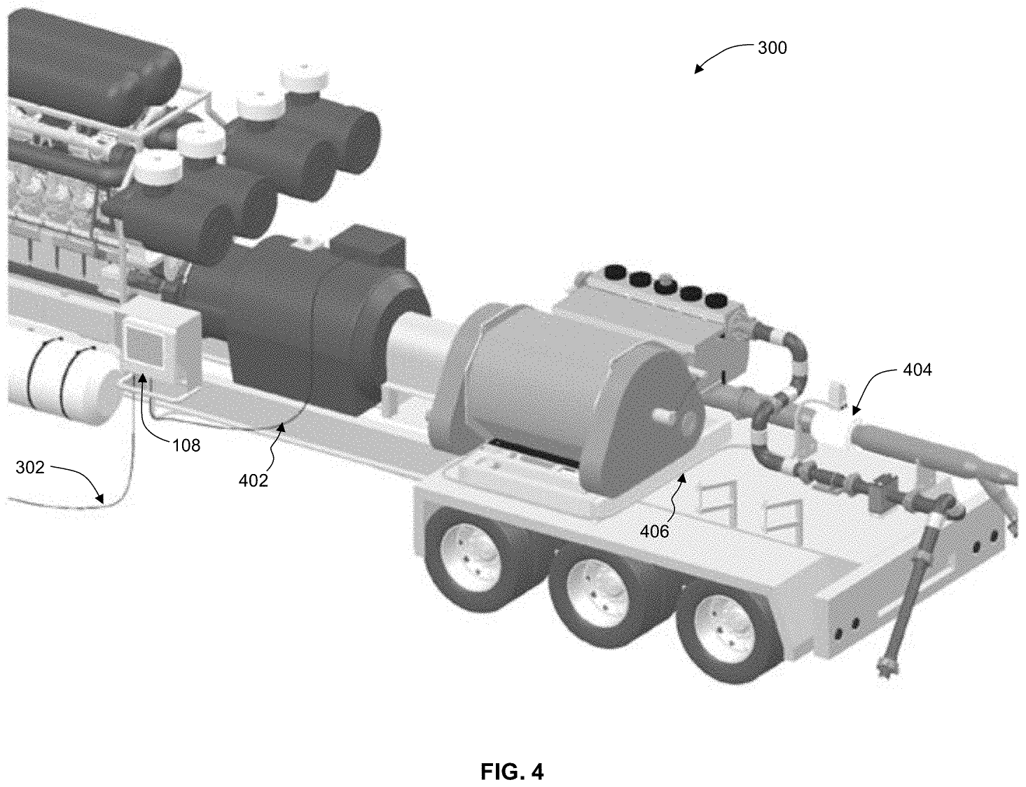

Referring now to FIG. 4, an image depicting a pumping mechanism 304 configured for use with second exemplary lubricant delivery system 300, according to an aspect of the present disclosure, is shown.

In order to facilitate control of pumping mechanism(s) 304, control station(s) 108 (and/or computing device(s) 104) may be connected to pumping mechanism(s) 304 via at least one transmission wire 402. Additionally, in order to facilitate the monitoring of one or more operating conditions of pumping mechanism(s) 304, each pumping mechanism 304 may be configured with at least one sensing device 216 in the form of at least one flow meter 404. By way of example and not limitation, each flow meter 404 may comprise at least one of: a magnetic flow meter, an electromagnetic flow meter, a turbine style flow meter, and a mass flow (i.e., Coriolis) flow meter. Depending on the type of flow meter 404 being used, each flow meter 404 may be configured to measure the linear, nonlinear, mass, volumetric, or similar flow rate of one or more lubricants being delivered to one or more lubricant recipients 110, including, in some nonlimiting exemplary embodiments, one or more pumping mechanisms 304. Each flow meter 404 may be communicatively coupled to control station(s) 108 (and/or computing device(s) 104) via wireless or wired connectivity, such as, by way of example and not limitation, via at least one flow meter signal line 406. As will be appreciated by those skilled in the relevant art(s) after reading the description herein, flow meter signal line(s) 406 may comprise a similar configuration and/or similar materials to lubricant source signal line(s) 202, sensing device signal line(s) 204, and/or data van signal line(s) 302.

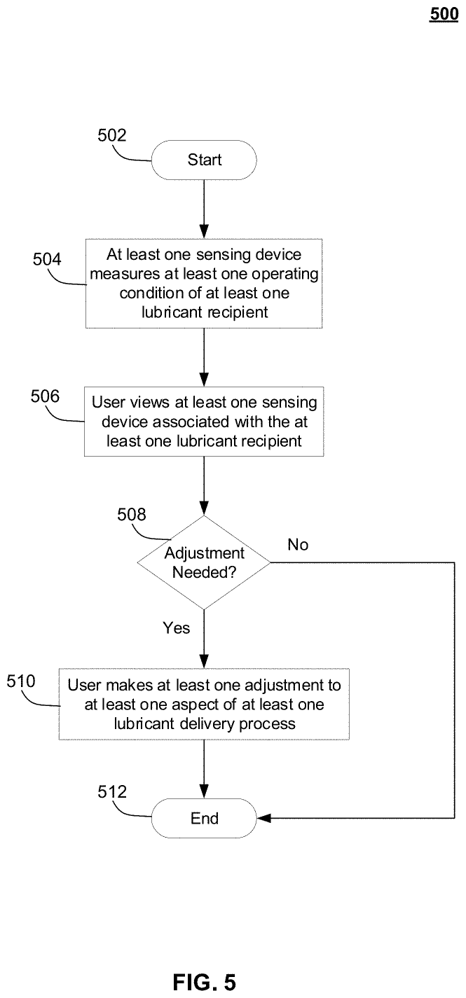

Referring now to FIG. 5, a flowchart illustrating an exemplary process 500 for facilitating the ability of at least one user 102 to manually view at least one operating condition of at least one lubricant recipient 110, and make at least one adjustment to at least one lubricant delivery process to the at least one lubricant recipient 110, according to an aspect of the present disclosure, is shown.

Process 500, which may at least partially execute within system 100 (not shown in FIG. 5), begins at step 502 with control passing immediately to step 504.

At step 504, at least one sensing device 216 (not shown in FIG. 5) associated with at least one lubricant recipient 110 (not shown in FIG. 5) measures, senses, or detects at least one operating condition of a given lubricant recipient 110. Such operating condition(s) may include, by way of example and not limitation, a temperature, a stroke count, a revolution count, a lubricant usage amount and/or an operating time of at least one portion of the at least one lubricant recipient 110, as well as any similar operating condition(s) as may be apparent to those skilled in the relevant art(s) after reading the description herein. In order to make this measurement or detection, each sensing device 216 may comprise, by way of example and not limitation, an RTD sensor, a thermometer, a motion detector, a timer, a velocity measuring device, a flow meter, an infrared sensor, a laser, a thermal scanner, a thermowell, a thermocouple, a thermistor, a resistance thermometer, a pyrometer, a pressure transducer, a digital gauge, a densimeter, a Langmuir probe, or any similar measurement, sensing, or detection device as may be apparent to those skilled in the relevant art(s) after reading the description herein.

At step 506, at least one user 102 (not shown in FIG. 5) views sensing device(s) 216 associated with lubricant recipient(s) 110 in order to obtain data or information regarding one or more operating conditions of lubricant recipient(s) 110, including but not limited to a temperature, a stroke count, a revolution count, a lubricant usage amount, and an operating time of at least one portion of the at least one lubricant recipient 110, as well as any similar operating condition(s) as may be apparent to those skilled in the relevant art(s) after reading the description herein. By way of example and not limitation, the data or information may be presented to user(s) 102 via one or more gauges, meters, display screens, monitors, or similar devices associated with sensing device(s) 216, computing device(s) 104 (not shown in FIG. 5), and/or control station(s) 108 (not shown in FIG. 5) (either directly or indirectly) as may be apparent to those skilled in the relevant art(s) after reading the description herein. In some aspects, when one or more operating conditions of lubricant recipient(s) 110 get to an unacceptable level, rate, or configuration, one or more auditory signals (e.g., a buzzer, alarm, beep, etc.) may be presented to user(s) 102 via one or more audio emitting devices (such as, for example and not limitation, one or more speakers, bells, etc.).

At step 508, the at least one user 102 determines whether any adjustments need to be made to any aspects of at least one lubricant delivery process to lubricant recipient(s) 110. By way of example and not limitation, the determination may be made at least partially based on whether the at least one user 102 thinks that lubricant recipient(s) 110 is operating less efficiently and/or effectively than it could be and/or whether the at least one user 102 thinks that continuing the operation of lubricant recipient(s) 110 under the current operating conditions may cause damage to lubricant recipient(s) 110 and/or one or more portions or components thereof (e.g., user 102 determines whether lubricant recipient(s) is 110 receiving an adequate amount of lubricant based on operating time, whether the temperature of lubricant recipient(s) 110 is going up as a result of unwanted friction, whether lubricant recipient(s) 110 is receiving an adequate amount of lubricant based on stroke or revolution count, whether lubricant recipient(s) 110 is using too much or too little lubricant, etc.). If the determination is in the affirmative, process 500 proceeds to step 510; if the determination is negative, process 500 proceeds to step 512.

At step 510, the at least one user 102 makes at least one adjustment to at least one aspect of at least one fluid delivery process to one or more lubricant recipients 110. By way of example and not limitation, the adjustment(s) may comprise one or more changes in the amount, flow rate, density, viscosity, and/or composition of one or more lubricants being delivered to lubricant recipient(s) 110, thereby helping to minimize or prevent damage and/or failure to lubricant recipient(s) 110 and/or one or more portions or components thereof. Other types of adjustments to other aspects of the at least one lubricant delivery process may be made as well as may be apparent to those skilled in the relevant art(s) after reading the description herein. In some nonlimiting exemplary embodiments, the adjustment(s) may be initiated by user(s) 102 manually adjusting one or more mechanisms or devices associated with one or more lubricant sources 106 (not shown in FIG. 5) (either directly or indirectly), one or more lubricant delivery lines 206 (not shown in FIG. 5) (either directly or indirectly), and/or one or more lubricant recipients 110 (either directly or indirectly), including but not limited to one or more discharge valves, suction valves, inlet valves, outlet valves, and/or other valves, as well as any similar lubricant delivery control mechanisms or devices as may be apparent to those skilled in the relevant art(s) after reading the description herein.

At step 512 process 500 is terminated and process 500 ends.

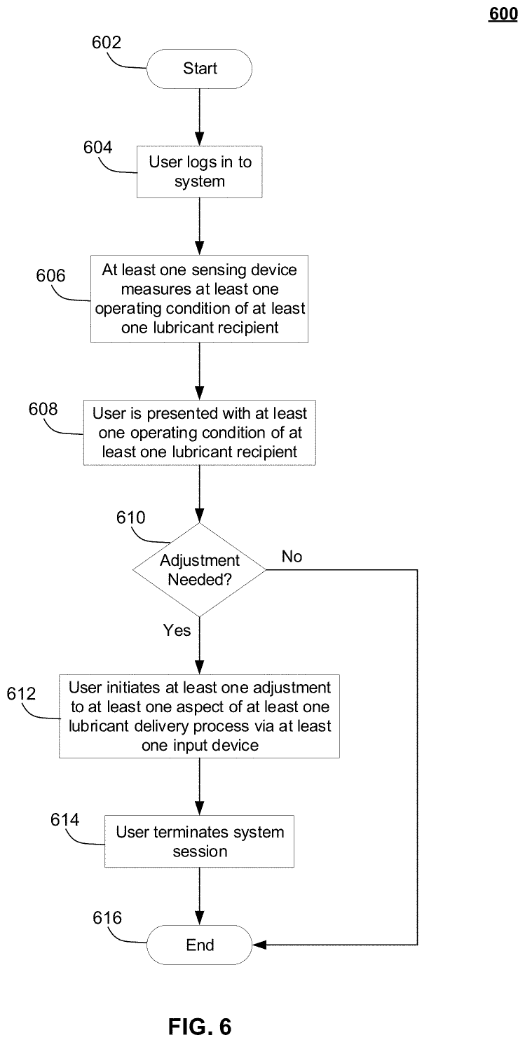

Referring now to FIG. 6, a flowchart illustrating an exemplary process 600 for facilitating the ability of at least one user 102 to use at least one computing device 104 to view at least one operating condition of at least one lubricant recipient 110 and make at least one adjustment to at least one aspect of at least one lubricant delivery process to the at least one lubricant recipient 110, according to an aspect of the present disclosure, is shown.

It is noted, generally, that any task performed via computing device(s) 104 may also be performed via control station(s) 108.

Process 600, which may at least partially execute within system 100 (not shown in FIG. 6), begins at step 602 with control passing immediately to step 604.

At step 604, at least one user 102 (not shown in FIG. 6) logs in to system 100 via a computing device 104 (not shown in FIG. 6) or control station 108 (not shown in FIG. 6). In some aspects, user 102, computing device 104, or control station 108 may provide login credentials, thereby allowing access to an account or profile associated with user 102. By way of example and not limitation, the login credentials may take place via a software application, a website, a web application, or the like accessed by computing device 104 or control station 108. By way of further example and not limitation, login credentials may comprise a username, password, passcode, key code, pin number, visual identification, fingerprint scan, retinal scan, voice authentication, facial recognition, and/or similar identifying and/or security elements as may be apparent to those skilled in the relevant art(s) after reading the description herein as being able to securely determine the identity of user 102. In some aspects, user 102 may login using a login service such as a social media login service, an identity/credential provider service, a single sign on service, and the like. In various aspects, users 102 may create user 102 accounts/profiles via such login services. Any user 102 accounts/profiles may, in some aspects, be stored within and retrieved from, by way of example and not limitation, user database 128 (not shown in FIG. 6). Once user 102 has successfully logged in to system 100, process 600 proceeds to step 606.

At step 606, at least one sensing device 216 (not shown in FIG. 6) associated with at least one lubricant recipient 110 (not shown in FIG. 6) measures, senses, or detects at least one operating condition of a given lubricant recipient 110. Such operating condition(s) may include, by way of example and not limitation, a temperature, a stroke count, a revolution count, a lubricant usage amount, and/or an operating time of at least one portion of the at least one lubricant recipient 110, as well as any similar operating condition(s) as may be apparent to those skilled in the relevant art(s) after reading the description herein. In order to make this measurement or detection, each sensing device 216 may comprise, by way of example and not limitation, an RTD sensor, a thermometer, a motion detector, a timer, a velocity measuring device, a flow meter, an infrared sensor, a laser, a thermal scanner, a thermowell, a thermocouple, a thermistor, a resistance thermometer, a pyrometer, a pressure transducer, a digital gauge, a densimeter, a Langmuir probe, or any similar measurement, sensing, or detection device as may be apparent to those skilled in the relevant art(s) after reading the description herein. In some aspects, sensing device(s) 216 may be communicatively coupled, either wirelessly or via wired connectivity, to computing device(s) 104 and/or control station(s) 108.

At step 608, at least one user 102 (not shown in FIG. 6) is presented with information regarding at least one operating condition of at least one lubricant recipient 110. By way of example and not limitation, such information may be presented via at least one graphical user interface presented by a monitor, display screen, or similar display device associated (either directly or indirectly) with computing device(s) 104 and/or control station(s) 108 communicatively coupled to sensing device(s) 216. Additionally or alternatively, the information may be presented upon one or more gauges, meters, display screens, monitors, or similar mechanisms or devices associated with sensing device(s) 216 (either directly or indirectly) as may be apparent to those skilled in the relevant art(s) after reading the description herein. The displayed information may comprise, by way of example and not limitation, a temperature, a stroke count, a revolution count, a lubricant usage amount, and/or an operating time of at least one portion of the at least one lubricant recipient 110, as well as any similar operating condition(s) as may be apparent to those skilled in the relevant art(s) after reading the description herein.

At step 610, the at least one user 102 determines whether any adjustments need to be made to at least one aspect of at least one lubricant delivery process to one or more lubricant recipients 110. By way of example and not limitation, the determination may be made at least partially based on whether the at least one user 102 thinks that lubricant recipient(s) 110 is operating less efficiently and/or effectively than it could be and/or whether the at least one user 102 thinks that continuing the operation of lubricant recipient(s) 110 under the current operating conditions may cause damage to lubricant recipient(s) 110 and/or one or more portions or components thereof (e.g., user 102 determines whether lubricant recipient(s) is 110 receiving an adequate amount of lubricant based on operating time, whether the temperature of lubricant recipient(s) 110 is going up as a result of unwanted friction, whether lubricant recipient(s) 110 is receiving an adequate amount of lubricant based on stroke or revolution count, whether lubricant recipient(s) 110 is using too much or too little lubricant, etc.). In some aspects, this determination may be at least partially made with the assistance of mathematical and/or computational analysis performed by one or more computing devices 104 and/or one or more control stations 108, comparing the detected/sensed/measured operating conditions of lubricant recipient(s) 110 to one or more predetermined standards or values (that, by way of example and not limitation, may be stored in and retrieved from lubricant recipient database 132) and determining whether the detected/sensed/measured operating conditions are outside of a tolerable deviation of the one or more predetermined standards or values (or outside of a tolerable range of such standards or values) based on the current lubricant delivery process configuration. If the determination is in the affirmative, process 600 proceeds to step 612; if the determination is negative, process 600 proceeds to step 616.

At step 612, the at least one user 102 initiates at least one adjustment to at least one aspect of at least one lubricant delivery process to one or more lubricant recipients 110 via at least one input device (such as, by way of example and not limitation, a mouse, keyboard, touchscreen, joystick, microphone, camera, scanner, chip reader, card reader, magnetic stripe reader, near field communication technology, and the like) associated with computing device(s) 104 and/or control station(s) 108 by using the input device(s) to identify the desired adjustment(s) via at least one graphical user interface presented by a monitor, display screen, or similar display device associated (either directly or indirectly) with computing device(s) 104 and/or control station(s) 108. By way of example and not limitation, the at least one adjustment to the at least one aspect of the at least one lubricant delivery process to lubricant recipient(s) 110 may comprise one or more changes in the amount, flow rate, density, viscosity, and/or composition of one or more lubricants being delivered to lubricant recipient(s) 110, thereby helping to minimize or prevent damage and/or failure to lubricant recipient(s) 110 and/or one or more portions or components thereof. Other types of adjustments to other aspects of the at least one lubricant delivery process may be made as well as may be apparent to those skilled in the relevant art(s) after reading the description herein. In order to instigate any adjustment(s) to the aspect(s) of the at least one lubricant delivery process requested by user(s) 102, computing device(s) 104 and/or control station(s) 108 may control the manipulation of one or more mechanisms or devices associated with one or more lubricant sources 106 (not shown in FIG. 6) (either directly or indirectly), one or more lubricant delivery lines 206 (not shown in FIG. 6) (either directly or indirectly), and/or one or more lubricant recipients 110 (either directly or indirectly), including but not limited to one or more discharge valves, suction valves, inlet valves, outlet valves, and other valves, as well as any similar lubricant delivery control mechanisms or devices as may be apparent to those skilled in the relevant art(s) after reading the description herein.

At step 614, the at least one user 102 terminates the open session within system 100. All communication between computing device(s) 104 and/or control station(s) 108 and system 100 may be closed. In some aspects, user 102 may log out of system 100, though this may not be necessary.

In various aspects, steps 604 and 614 of process 600 may be omitted, as user(s) 102 may not be required to log in or log out of system 100.

At step 616 process 600 is terminated and process 600 ends.

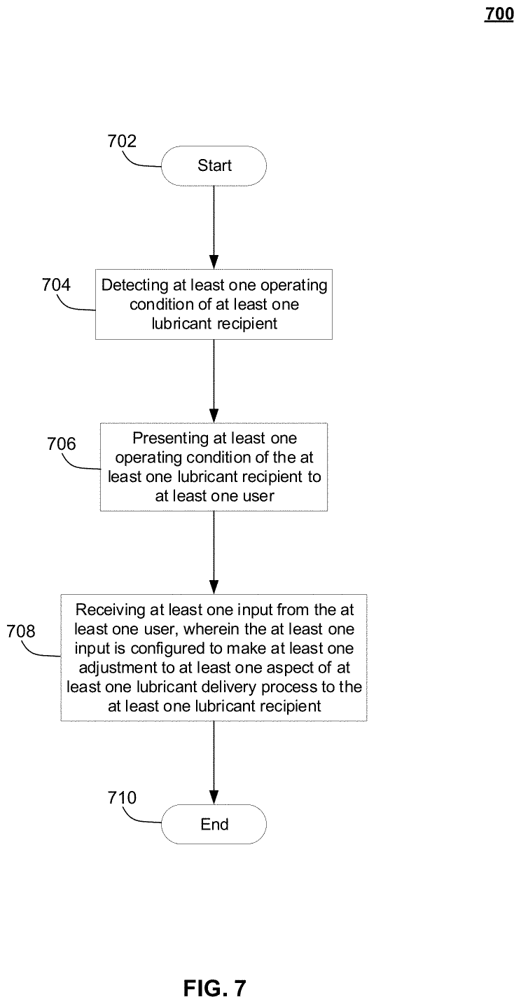

Referring now to FIG. 7, a flowchart illustrating an exemplary process 700 for facilitating the ability of at least one user 102 to assess at least one operating condition of at least one lubricant recipient 110 and make at least one adjustment to at least one aspect of at least one lubricant delivery process to the at least one lubricant recipient 110, according to an aspect of the present disclosure, is shown.

Process 700, which may at least partially execute within system 100 (not shown in FIG. 7), begins at step 702 with control passing immediately to step 704.

At step 704, system 100 measures, senses, or detects at least one operating condition of at least one lubricant recipient 110 (not shown in FIG. 7). By way of example and not limitation, the detection may be made by one or more sensing devices 216 (not shown in FIG. 7) that may be associated, either directly or indirectly, with a given lubricant recipient 110. By way of further example and not limitation, the at least one detected operating condition of lubricant recipient(s) 110 may comprise a temperature, a stroke count, a revolution count, a lubricant usage amount, and/or an operating time of at least one portion of the at least one lubricant recipient 110, as well as any similar operating condition(s) as may be apparent to those skilled in the relevant art(s) after reading the description herein. In order to make this measurement or detection, each sensing device 216 may comprise, by way of example and not limitation, an RTD sensor, a thermometer, a motion detector, a timer, a velocity measuring device, a flow meter, an infrared sensor, a laser, a thermal scanner, a thermowell, a thermocouple, a thermistor, a resistance thermometer, a pyrometer, a pressure transducer, a digital gauge, a densimeter, a Langmuir probe, or any similar measurement, sensing, or detection device as may be apparent to those skilled in the relevant art(s) after reading the description herein. In some aspects, sensing device(s) 216 may be communicatively coupled, either wirelessly or via wired connectivity, to computing device(s) 104 (not shown in FIG. 7) and/or control station(s) 108 (not shown in FIG. 7).

At step 706, system 100 presents information regarding the at least one measured/sensed/detected operating condition of lubricant recipient(s) 110 to at least one user 102 (not shown in FIG. 7). By way of example and not limitation, such information may be displayed via at least one graphical user interface upon one or more display screens, monitors, or similar display devices associated with computing device(s) 104 and/or control station(s) 108 (either directly or indirectly) that may be communicatively coupled (either wirelessly or via wired connectivity) to one or more sensing devices 216, or via one or more display screens, monitors, gauges, meters, and/or similar devices or mechanisms that may be communicatively coupled (either wirelessly or via wired connectivity) to one or more sensing devices 216 and that may be apparent to those skilled in the relevant art(s) after reading the description herein as being able to present information in a variety of forms to at least one user 102. The displayed information may comprise, by way of example and not limitation, a temperature, a stroke count, a revolution count, a lubricant usage amount, and/or an operating time of at least one portion of the at least one lubricant recipient 110, as well as any similar operating condition(s) that may be apparent to those skilled in the relevant art(s) after reading the description herein. In some aspects, when one or more operating conditions of lubricant recipient(s) 110 get to an unacceptable level, rate, or configuration, one or more auditory signals (e.g., a buzzer, alarm, beep, etc.) may be presented to user(s) 102 via one or more audio emitting devices (such as, for example and not limitation, one or more speakers, bells, etc.).

At step 708, system 100 receives at least one input from the at least one user 102 in order to initiate at least one adjustment to at least one aspect of at least one lubricant delivery process to one or more lubricant recipients 110. By way of example and not limitation, the at least one input may be received via at least one input device (such as, by way of example and not limitation, a mouse, keyboard, touchscreen, joystick, microphone, camera, scanner, chip reader, card reader, magnetic stripe reader, near field communication technology, and the like) that may be associated with computing device(s) 104 and/or control station(s) 108. By way of further example and not limitation, the at least one adjustment to the at least one aspect of a given lubricant delivery process may comprise one or more changes in the amount, flow rate, density, viscosity, and/or composition of one or more lubricants being delivered to lubricant recipient(s) 110, thereby helping to minimize or prevent damage and/or failure to lubricant recipient(s) 110 and/or one or more portions or components thereof. Other types of adjustments to other aspects of the at least one lubricant delivery process may be made as well as may be apparent to those skilled in the relevant art(s) after reading the description herein. In order to instigate any adjustment(s) to the aspect(s) of the at least one lubricant delivery process requested by user(s) 102, computing device(s) 104 and/or control station(s) 108 may control the manipulation of one or more mechanisms or devices associated with one or more lubricant sources 106 (not shown in FIG. 7) (either directly or indirectly), one or more lubricant delivery lines 206 (not shown in FIG. 7) (either directly or indirectly), and/or one or more lubricant recipients 110 (either directly or indirectly), including but not limited to one or more discharge valves, suction valves, inlet valves, outlet valves, and other valves, as well as any similar lubricant delivery control mechanisms or devices as may be apparent to those skilled in the relevant art(s) after reading the description herein. In some aspects, user(s) 102 may control the manipulation of such mechanisms or devices manually.

At step 710 process 700 is terminated and process 700 ends.

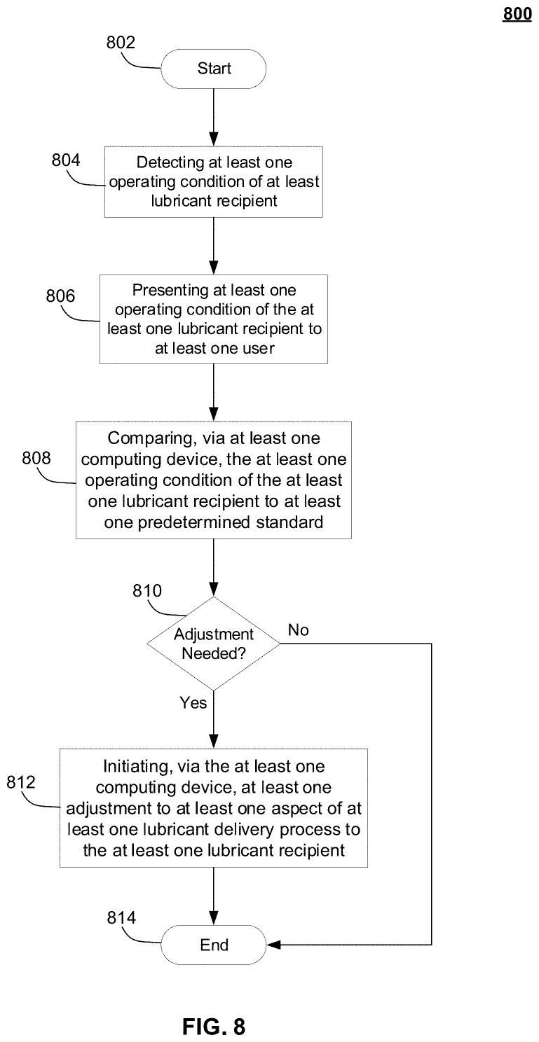

Referring now to FIG. 8, a flowchart illustrating an exemplary process 800 for facilitating the ability of at least one computing device 104, to detect at least one operating condition of at least one lubricant recipient 110, and make at least one adjustment to at least one aspect of at least one lubricant delivery process to the at least one lubricant recipient 110, according to an aspect of the present disclosure, is shown.

It is noted, generally, that any task performed via computing device(s) 104 may also be performed via control station(s) 108.

Process 800, which may at least partially execute within system 100 (not shown in FIG. 8), begins at step 802 with control passing immediately to step 804.

At step 804, system 100 measures, senses, or detects at least one operating condition of at least one lubricant recipient 110 (not shown in FIG. 8). By way of example and not limitation, the detection may be made by one or more sensing devices 216 (not shown in FIG. 8) that may be associated, either directly or indirectly, with a given lubricant recipient 110. By way of further example and not limitation, the at least one detected operating condition of lubricant recipient(s) 110 may comprise a temperature, a stroke count, a revolution count, a lubricant usage amount, and/or an operating time of at least one portion of the at least one lubricant recipient 110, as well as any similar operating condition(s) as may be apparent to those skilled in the relevant art(s) after reading the description herein. In order to make this measurement or detection, each sensing device 216 may comprise, by way of example and not limitation, an RTD sensor, a thermometer, a motion detector, a timer, a velocity measuring device, a flow meter, an infrared sensor, a laser, a thermal scanner, a thermowell, a thermocouple, a thermistor, a resistance thermometer, a pyrometer, a pressure transducer, a digital gauge, a densimeter, a Langmuir probe, or any similar measurement, sensing, or detection device as may be apparent to those skilled in the relevant art(s) after reading the description herein. In some aspects, sensing device(s) 216 may be communicatively coupled, either wirelessly or via wired connectivity, to computing device(s) 104 (not shown in FIG. 8) and/or control station(s) 108 (not shown in FIG. 8).

At step 806, system 100 presents information regarding the at least one measured/sensed/detected operating condition of lubricant recipient(s) 110 to at least one user 102 (not shown in FIG. 8). By way of example and not limitation, such information may be displayed via at least one graphical user interface presented upon one or more display screens, monitors, or similar display devices associated with computing device(s) 104 and/or control station(s) 108 (either directly or indirectly) that may be communicatively coupled (either wirelessly or via wired connectivity) to one or more sensing devices 216, or via one or more display screens, monitors, gauges, meters, and/or similar devices or mechanisms that may be communicatively coupled (either wirelessly or via wired connectivity) to one or more sensing devices 216 and that may be apparent to those skilled in the relevant art(s) after reading the description herein as being able to present information in a variety of forms to at least one user 102. The displayed information may comprise, by way of example and not limitation, a temperature, a stroke count, a revolution count, a lubricant usage amount, and/or an operating time of at least one portion of the at least one lubricant recipient 110, as well as any similar operating condition(s) as may be apparent to those skilled in the relevant art(s) after reading the description herein. In some aspects, when one or more operating conditions of lubricant recipient(s) 110 get to an unacceptable level, rate, or configuration, one or more auditory signals (e.g., a buzzer, alarm, beep, etc.) may be presented to user(s) 102 via one or more audio emitting devices (such as, for example and not limitation, one or more speakers, bells, etc.).

In some aspects, step 806 may be skipped as it may not be necessary to present any information to any user(s) 102.

At step 808, system 100 compares the at least one measured/sensed/detected operating condition of the at least one lubricant recipient 110 to at least one predetermined standard or value (or a range of such predetermined standards or values) via computing device(s) 104 and/or control station(s) 108 based on the current lubricant delivery process configuration. In some nonlimiting exemplary embodiments, the at least one predetermined standard or value may be stored in and retrieved from, by way of example and not limitation, lubricant recipient database 132. By way of example and not limitation, the at least one predetermined standard or value may comprise a preferred and/or optimal temperature, stroke count, revolution count, lubricant usage amount, operating time, and/or similar operating condition of a given lubricant recipient 110 based on the current lubricant amount, flow rate, density, viscosity, composition, and/or similar lubricant delivery process aspect(s) as determined by one or more users 102, computing device(s) 104 and/or control station(s) 108, and/or a manufacturer or service technician of lubricant recipient 110. In some additional nonlimiting exemplary embodiments, the at least one predetermined standard or value may comprise a range of preferred and/or optimal temperatures, stroke counts, revolution counts, lubricant usage amounts, operating times, and/or similar operating conditions based on the current lubricant amount, flow rate, density, viscosity, composition, and/or similar lubricant delivery process aspect(s) of a given lubricant recipient 110 as determined by one or more users 102, computing device(s) 104 and/or control station(s) 108, and/or a manufacturer or service technician of lubricant recipient 110.

At step 810, system 100 determines whether any adjustments need to be made to at least one aspect of at least one lubricant delivery process to one or more lubricant recipients 110. By way of example and not limitation, the determination may be made at least partially based on whether system 100 determines, via mathematical and/or computational analysis, that lubricant recipient(s) 110 is operating less efficiently and/or effectively than it could be and/or that continuing the operating of lubricant recipient(s) 110 under the current operating conditions may cause damage to lubricant recipient(s) 110 and/or one or more portions thereof (e.g., determining whether lubricant recipient(s) is 110 receiving an adequate amount of lubricant based on operating time, whether the temperature of lubricant recipient(s) 110 is going up as a result of unwanted friction, whether lubricant recipient(s) 110 is receiving an adequate amount of lubricant based on stroke or revolution count, whether lubricant recipient(s) 110 is using too much or too little lubricant, etc.). Additionally, the determination may be at least partially based upon whether at least one operating condition of lubricant recipient(s) 110 is not within a tolerable deviation of the at least one predetermined standard or value referenced during the comparison performed at step 808 and therefore requires at least one change or adjustment in the lubricant delivery process being provided to lubricant recipient(s) 110. If the determination is in the affirmative, process 800 proceeds to step 812; if the determination is negative, process 800 proceeds to step 814.

At step 812, system 100 initiates at least one adjustment to at least one aspect of at least one lubricant delivery process to one or more lubricant recipients 110 via computing device(s) 104 and/or control station(s) 108. By way of example and not limitation, the at least one adjustment to the at least one aspect of the at least one lubricant delivery process may comprise one or more changes in the amount, flow rate, density, viscosity, and/or composition of one or more lubricants being delivered to lubricant recipient(s) 110, thereby helping to minimize or prevent damage and/or failure to lubricant recipient(s) 110 and/or one or more portions or components thereof. Other types of adjustments to other aspects of the at least one lubricant delivery process may be made as well as may be apparent to those skilled in the relevant art(s) after reading the description herein. In order to instigate any adjustment(s) to the aspect(s) of the at least one lubricant delivery process that are determined to be necessary or desirable, computing device(s) 104 and/or control station(s) 108 may control the manipulation of one or more mechanisms or devices associated with one or more lubricant sources 106 (not shown in FIG. 8) (either directly or indirectly), one or more lubricant delivery lines 206 (not shown in FIG. 8) (either directly or indirectly), and/or one or more lubricant recipients 110 (either directly or indirectly), including but not limited to one or more discharge valves, suction valves, inlet valves, outlet valves, and other valves, as well as any similar lubricant delivery control mechanisms or devices as may be apparent to those skilled in the relevant art(s) after reading the description herein.

At step 814 process 800 is terminated and process 800 ends.

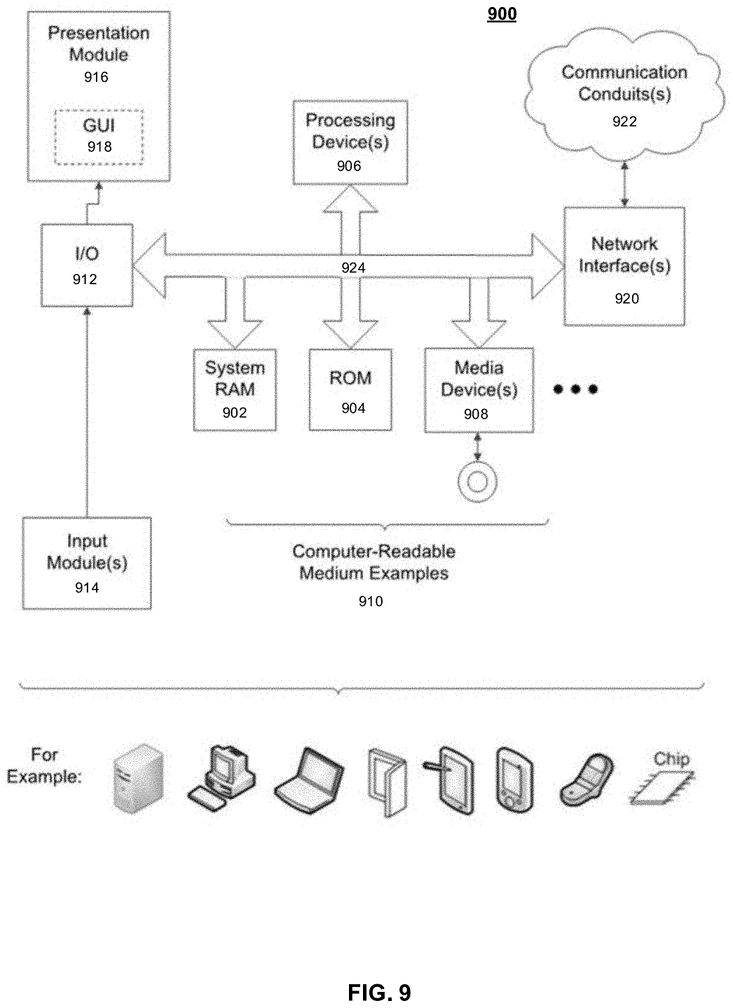

Referring now to FIG. 9, a block diagram of an exemplary computing system 900 useful for implementing one or more aspects of the present disclosure, is shown.

FIG. 9 sets forth illustrative computing functionality 900 that may be used to implement web server(s) 124, application server(s) 126, one or more gateways 112-122, user database 128, control station database 130, lubricant recipient database 132, computing devices 104 utilized by user(s) 102 to access Internet 134, control station(s) 108 to facilitate interaction between user(s) 102 and one or more lubricant sources 106 and/or lubricant recipients 110, or any other component of system 100. In all cases, computing functionality 900 represents one or more physical and tangible processing mechanisms.

Computing functionality 900 may comprise volatile and non-volatile memory, such as RAM 902 and ROM 904, as well as one or more processing devices 906 (e.g., one or more central processing units (CPUs), one or more graphical processing units (GPUs), and the like). Computing functionality 900 also optionally comprises various media devices 908, such as a hard disk module, an optical disk module, and so forth. Computing functionality may perform various operations identified when the processing device(s) 906 execute(s) instructions that are maintained by memory (e.g., RAM 902, ROM 904, and the like).

More generally, instructions and other information may be stored on any computer readable medium 910, including, but not limited to, static memory storage devices, magnetic storage devices, and optical storage devices. The term “computer readable medium” also encompasses plural storage devices. In all cases, computer readable medium 910 represents some form of physical and tangible entity. By way of example and not limitation, computer readable medium 910 may comprise “computer storage media” and “communications media.”

“Computer storage media” comprises volatile and non-volatile, removable and non-removable implemented in any method or technology for storage of information, such as computer readable instructions, data structures, program modules, or other data. Computer storage media may be, for example, and not limitation, RAM 902, ROM 904, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 900 may also comprise an input/output module 912 for receiving various inputs (via input modules 914), and for providing various outputs (via one or more output modules). One particular output module mechanism may be a presentation module 916 and an associated GUI 918. Computing functionality 900 may also include one or more network interfaces 920 for exchanging data with other devices via one or more communication conduits 922. In some aspects, one or more communication buses 924 communicatively couple the above-described components together.

Communication conduit(s) 922 may be implemented in any manner (e.g., by a local area network, a wide area network (e.g., the Internet), and the like, or any combination thereof). Communication conduit(s) 922 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or any combination thereof. In the case of a software implementation, the module or component represents program code that performs specified tasks when executed on one or more processors. The program code may be stored in one or more computer readable memory devices, as described with reference to FIG. 9. The features of the present disclosure described herein are platform-independent, meaning the techniques can be implemented on a variety of commercial computing platforms having a variety of processors (e.g., desktop, laptop, notebook, tablet computer, personal digital assistant (PDA), mobile telephone, smart telephone, gaming console, and the like).

In view of the above, a non-transitory processor readable storage medium is provided. The storage medium comprises an executable computer program product which further comprises a computer software code that, when executed on a processor, causes the processor to perform certain steps or processes. Such steps may include, but are not limited to, causing the processor to detect at least one operating condition of at least one lubricant recipient 110, present the at least one operating condition to at least user 102, and receive at least one input from the at least one user 102, wherein the at least one input is configured to make at least one adjustment to at least one aspect of at least one lubricant delivery process to the at least one lubricant recipient 110. Such steps may also include, without limitation, causing the processor to compare at least one operating condition of the at least one lubricant recipient 110 to at least one predetermined standard or value; determine whether at least one operating condition of the at least one lubricant recipient 110 is within a tolerable deviation of the at least one predetermined standard or value, and if the at least one operating condition is not within a tolerable deviation of the at least one predetermined standard or value, initiate at least one adjustment to at least one aspect of at least one lubricant delivery process to the at least one lubricant recipient 110.

It is noted that the order of the steps of processes 500-800, including the starting points thereof, may be altered without departing from the scope of the present disclosure, as will be appreciated by those skilled in the relevant art(s) after reading the description herein.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., utilization with different lubricants or lubricant sources; utilization of different lubricant recipients; implementation within computing devices, environments, and methods other than those mentioned herein). As will be appreciated by those skilled in the relevant art(s) after reading the description herein, certain features from different aspects of the systems, methods, and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A lubricant delivery system configured to deliver at least one amount of at least one lubricant to at least one lubricant recipient, the lubricant delivery system comprising:
at least one lubricant source;
at least one lubricant delivery line configured to at least partially contain the at least one amount of the at least one lubricant;
at least one lubricant recipient; and
at least one sensing device configured to detect at least one operating condition of the at least one lubricant recipient.

2. The lubricant delivery system of claim 1, wherein the at least one lubricant comprises at least one of: oil, grease, viscous lubricating fluid, putty, and paste.

3. The lubricant delivery system of claim 1, wherein the at least one lubricant recipient comprises a pumping mechanism.

4. The lubricant delivery system of claim 3, wherein the pumping mechanism comprises the at least one sensing device.

5. The lubricant delivery system of claim 1, wherein the at least one sensing device comprises at least one of: a resistance temperature detector, a thermometer, a motion detector, a timer, a velocity measuring device, a flow meter, an infrared sensor, a laser, a thermal scanner, a thermowell, a thermocouple, a thermistor, a resistance thermometer, a pyrometer, a pressure transducer, a digital gauge, a densimeter, and a Langmuir probe.

6. The lubricant delivery system of claim 1, wherein the at least one operating condition of the at least one lubricant recipient comprises at least one of: a temperature of at least one portion of the at least one lubricant recipient, a stroke count of the at least one lubricant recipient, a revolution count of the at least one lubricant recipient, an amount of lubricant used by the at least one lubricant recipient, and an operating time of the at least one lubricant recipient.

7. The lubricant delivery system of claim 1, wherein the at least one lubricant source comprises at least one of: a storage tank, a reservoir, a container, and a blending apparatus.

8. The lubricant delivery system of claim 1, wherein the at least one lubricant recipient comprises at least one of: a pressure pump, a piece of farming equipment, a mining apparatus, a petrochemical system, one or more rear-end automotive bearings, one or more wheel bearings, one or more trailer bearings, one or more auger bearings, one or more crankshafts, one or more pinion shafts, and one or more cam bearings.

9. The lubricant delivery system of claim 1, wherein the lubricant delivery system further comprises at least one computing device communicatively coupled to the at least one sensing device.

10. The lubricant delivery system of claim 9, wherein the at least one computing device is connected to at least one of: the at least one lubricant source and the at least one sensing device via at least one signal line.

11. A method for using a lubricant delivery system to deliver at least one amount of at least one lubricant from at least one lubricant source to at least one lubricant recipient based at least partially on at least one operating condition of the at least one lubricant recipient, wherein the lubricant delivery system comprises: the at least one lubricant source, at least one lubricant delivery line configured to at least partially contain the at least one amount of the at least one lubricant, the at least one lubricant recipient, and at least one sensing device configured to detect the at least one operating condition of the at least one lubricant recipient, the method comprising:
detecting at least one operating condition of the at least one lubricant recipient via the at least one sensing device.

12. The method of claim 11, wherein the method further comprises: presenting the at least one operating condition to at least one user; and
receiving at least one input from the at least one user, wherein the at least one input is configured to make at least one adjustment to at least one aspect of at least one lubricant delivery process to the at least one lubricant recipient.

13. The method of claim 11, wherein the at least one lubricant comprises at least one of: oil, grease, viscous lubricating fluid, putty, and paste.

14. The method of claim 11, wherein the at least one lubricant recipient comprises a pumping mechanism.

15. The method of claim 14, wherein the pumping mechanism comprises the at least one sensing device.

16. The method of claim 11, wherein the at least one sensing device comprises at least one of: a resistance temperature detector, a thermometer, a motion detector, a timer, a velocity measuring device, a flow meter, an infrared sensor, a laser, a thermal scanner, a thermowell, a thermocouple, a thermistor, a resistance thermometer, a pyrometer, a pressure transducer, a densimeter, a digital gauge, and a Langmuir probe.

17. The method of claim 11, wherein the at least one operating condition of the at least one lubricant recipient comprises at least one of: a temperature of at least one portion of the at least one lubricant recipient, a stroke count of the at least one lubricant recipient, a revolution count of the at least one lubricant recipient, an amount of lubricant used by the at least one lubricant recipient, and an operating time of the at least one lubricant recipient.

18. The method of claim 11, wherein the lubricant delivery system further comprises at least one computing device communicatively coupled to the at least one sensing device.

19. The method of claim 18, wherein the method further comprises:
comparing, via the at least one computing device, the at least one operating condition of the at least one lubricant recipient to at least one predetermined standard.

20. The method of claim 19, wherein the method further comprises:
determining, via the at least one computing device, whether the at least one operating condition of the at least one lubricant recipient is within a tolerable deviation of the at least one predetermined standard; and
initiating, via the at least one computing device, at least one adjustment to at least one aspect of at least one lubricant delivery process to the at least one lubricant recipient.
